(19) United States
(12) Patent Application Publication
(10) Pub. No.: US 2024/0010077 A1
(43) Pub. Date: Jan. 11, 2024

(54) BATTERY PACK FOR THE PROPULSION OF AN ELECTRIC VEHICLE

(71) Applicant: INTERACTIVE FULLY ELECTRICAL VEHICLES S.R.L., La Loggia (Torino) (IT)

(72) Inventors: Pietro PERLO, La Loggia (Torino) (IT); Davide PENSERINI, La Loggia (Torino) (IT); Sergio POZZATO, La Loggia (Torino) (IT); Marco BIASIOTTO, La Loggia (Torino) (IT); Marco GROSSO, La Loggia (Torino) (IT); Ricardo INTROZZI, La Loggia (Torino) (IT); Gioele SABATO, La Loggia (Torino) (IT)

(73) Assignee: INTERACTIVE FULLY ELECTRICAL VEHICLES S.R.L., La Loggia (Torino) (IT)

(21) Appl. No.: 17/754,589

(22) PCT Filed: Oct. 1, 2020
(86) PCT No.: PCT/IB2020/059192

§ 371 Date: Apr. 6, 2022

(30) Foreign Application Priority Data
Oct. 7, 2019 (IT) 102019000018116

(51) Int. Cl. B60L 50/64; H01M 10/647; B60L 50/60; H01M 10/643; H01M 10/6568; H01M 10/6555; H01M 50/509; H01M 50/249; H01M 10/625

(52) U.S. Cl. CPC B60L 50/64; H01M 10/647; B60L 50/66; H01M 10/643; H01M 10/6568; H01M 10/6555; H01M 50/509; H01M 50/249; H01M 10/625; B60Y 2306/01

(57) ABSTRACT

A battery pack for the propulsion of electric road, boat or aircraft vehicles, includes a plurality of battery modules. The battery cells of the pack are arranged with their planes oriented horizontally, according to a “lasagna” configuration, over a lower tray. Superimposed layers of cells are provided, separated by aluminum sheets, which hinder the propagation of heat and flame. Between the cells there are tubes of a circuit for a coolant or alternatively a cooling panel is provided under the cell layers. The cells have one side glued to an adjacent aluminum sheet and the opposite side also glued to an adjacent aluminum sheet or covered by a pad of elastically deformable material. The terminals of some cells side-by-side are connected to each other by means of bars held in position by clamps, with an arrangement such as to simplify the assembly procedure.

### FIELD OF THE INVENTION

The present invention refers to battery packs for the propulsion of electric vehicles of any type, that is, road vehicles and boats and aircraft.

The invention relates in particular to a battery pack of the type comprising a plurality of battery modules, each including a plurality of clusters of battery cells, which are arranged side-by-side within a containment space.

### PRIOR ART

The Applicant has proposed—in the recent past—a new electric vehicle configuration (see, for example, the international patent application WO 2016/055874 A1) comprising a high-strength steel reticular frame and a platform solidly connected to the reticular frame designed to house a battery pack, consisting of a plurality of battery cells.

The design of the battery pack is a fundamental factor for the success of an electric vehicle, particularly in the case of a small vehicle, such as an electric city car. On the one hand, it is in fact necessary to house a sufficient number of battery cells to ensure relatively high voltage and power supply, while identifying at the same time an arrangement of the battery cells that constitutes the most rational solution possible in terms of space occupied in the vehicle.

A significant problem encountered in this field is that of ensuring a maximum level of safety and robustness of the battery pack, which takes into account the electro-thermal changes in the elastic shape of the battery cells that occur during the charging and discharging cycle of the battery cells and/or as a result of permanent structural changes induced by continued use and aging of battery cells.

The battery cell assembly is typically contained in a containment space having a substantially predetermined and constant size. It is therefore necessary to configure the battery pack in such a way as to allow expansions or contractions of the individual battery cells within said containment space of predetermined dimensions. In battery packs using “pouch”-type battery cells, wherein the battery cells have substantially flattened and elongated bodies and are arranged in mutually adjacent positions, it is known to interpose panels (“pads”) of elastically deformable material between the cells (for example, made of silicon sponge), which are able to allow, with their elastic reduction in thickness, a minimum degree of expansion of the cells. However, this solution has proved to be totally unsatisfactory, in that the aforesaid pads are able to absorb only a minimal fraction (in the order of 1/10) of the total expansion of a cluster of cells during its operation, and in that the material needed to make such pads is relatively expensive. More importantly, when the aforesaid pads are not able to absorb an expansion of the battery cells caused both by the permanent electro-thermal expansion due to aging and wear and by the production of gas inside the cells, structural breakages could occur, with gas leaks, which are naturally flammable.

There is therefore a need to propose new configurations of battery packs that are capable of efficiently solving the aforesaid technical problem, ensuring high levels of safety without requiring major structural complications and significant cost increases.

Another relevant problem in the field of battery packs of the type described above consists in the need to make it possible to assemble the battery pack with simple operations that can be automated as much as possible.

It is also important that the cost and weight of all the components required for assembling the battery cells into a battery pack are a minimal fraction of the cost and weight of the battery cells taken on their own.

Still a further problem is that of making the battery pack in such a way that it is easy to install on the vehicle.

Another problem is that of identifying arrangements of the battery cells that allow adopting wiring as simplified as possible in order to monitor the temperature and the state of health of each battery cell.

Still a further problem is that of identifying architectures that facilitate the thermal conditioning of the battery pack by means of thermal insulation of the casing that contains it.

Another problem is to identify battery pack architectures that ensure temperature uniformity in the entire volume of the battery pack, allowing separation of the battery pack into zones in order to avoid the spread of high temperatures or a flame between different zones of the battery pack.

Still another problem is to define a battery pack architecture that is particularly robust and that, in particular, is able to withstand high frequency vibrations and the stresses resulting from impacts in the crash tests to which the vehicle must be subjected for its approval.

Up to now, no solution has yet been proposed which would allow all the aforesaid problems to be satisfactorily resolved.

### OBJECT AND SUMMARY OF THE INVENTION

In view of solving the aforesaid problems, the invention relates to a battery pack having the characteristics indicated in the attached claim 1.

Further preferred characteristics and advantages are indicated in the dependent claims.

### DETAILED DESCRIPTION OF SOME PREFERRED EMBODIMENTS

Further characteristics and advantages of the invention will become apparent from the description that follows with reference to the attached drawings, provided purely by way of non-limiting example, wherein:

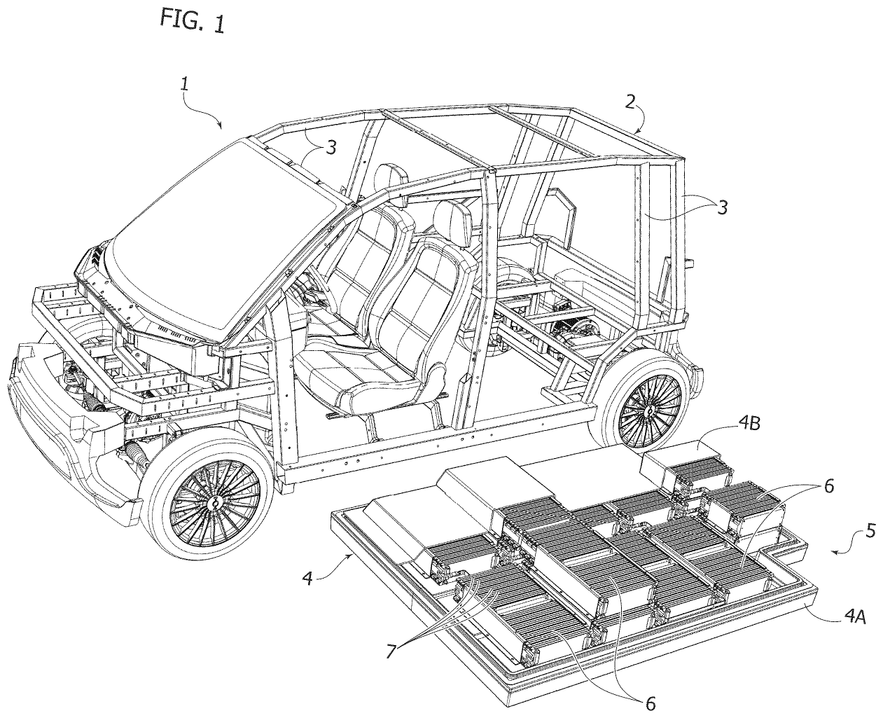

FIG. 1 is an exploded perspective view of the structure of an electric vehicle containing a battery pack according to the invention,

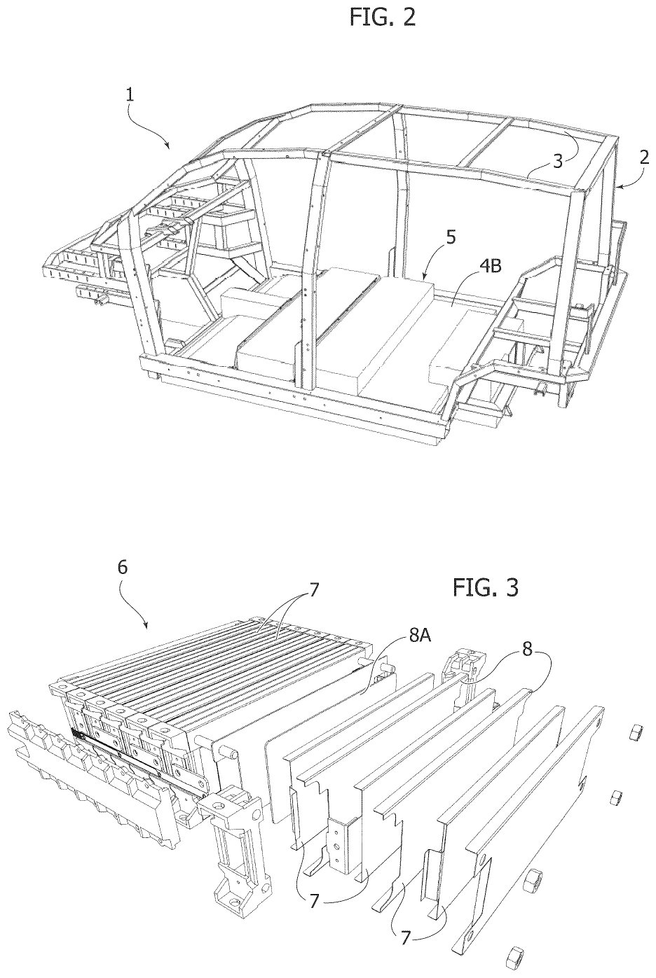

FIG. 2 is an additional perspective view of the vehicle structure of FIG. 1, with the battery pack illustrated in the assembled condition and integrated into the vehicle platform,

FIG. 3 is an exploded perspective view of a battery module according to the prior art,

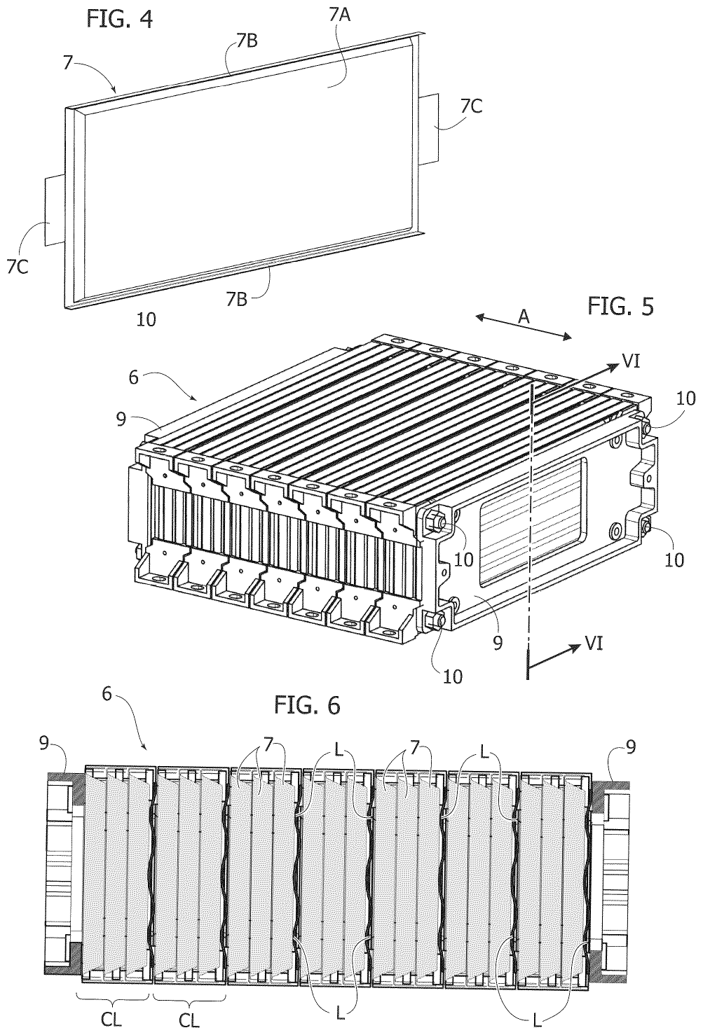

FIG. 4 is a perspective view of a battery cell of the “pouch” type used in the battery module of FIG. 3,

FIG. 5 is a perspective view of a battery module made in accordance with a first embodiment of the present invention,

FIG. 6 is a cross-sectional view along the line VI-VI of FIG. 5,

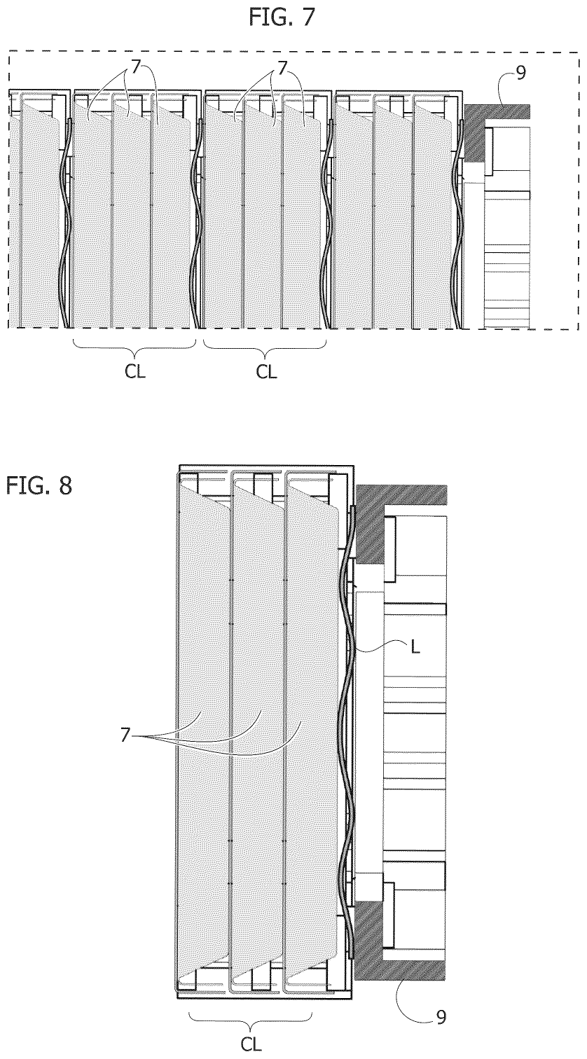

FIG. 7 is a view on an enlarged scale of a detail of FIG. 6,

FIG. 8 is another view on an enlarged scale of a detail of FIG. 6,

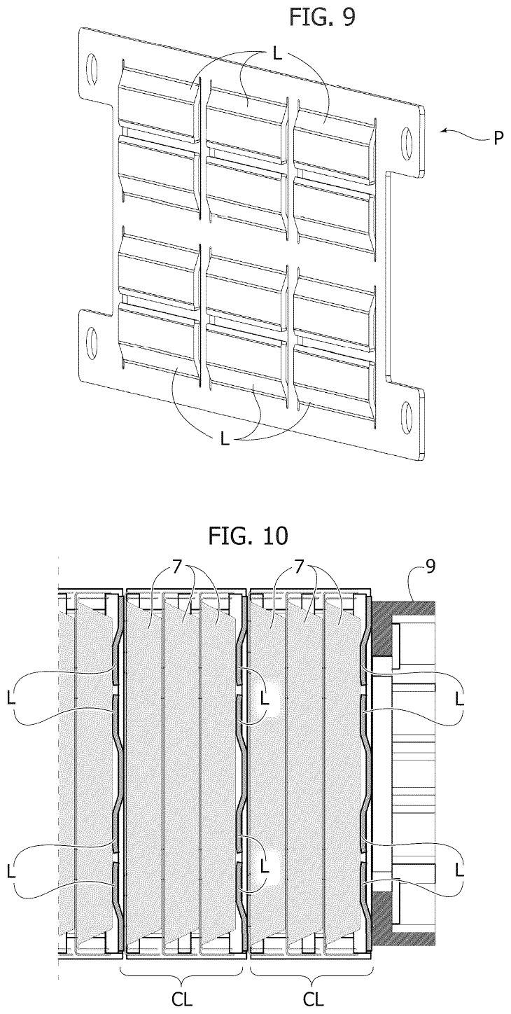

FIG. 9 is a perspective view of a panel with elastic tabs used in a second embodiment of the battery pack according to the invention,

FIG. 10 illustrates the same detail of FIGS. 7,8 with reference to the second embodiment described in FIG. 9,

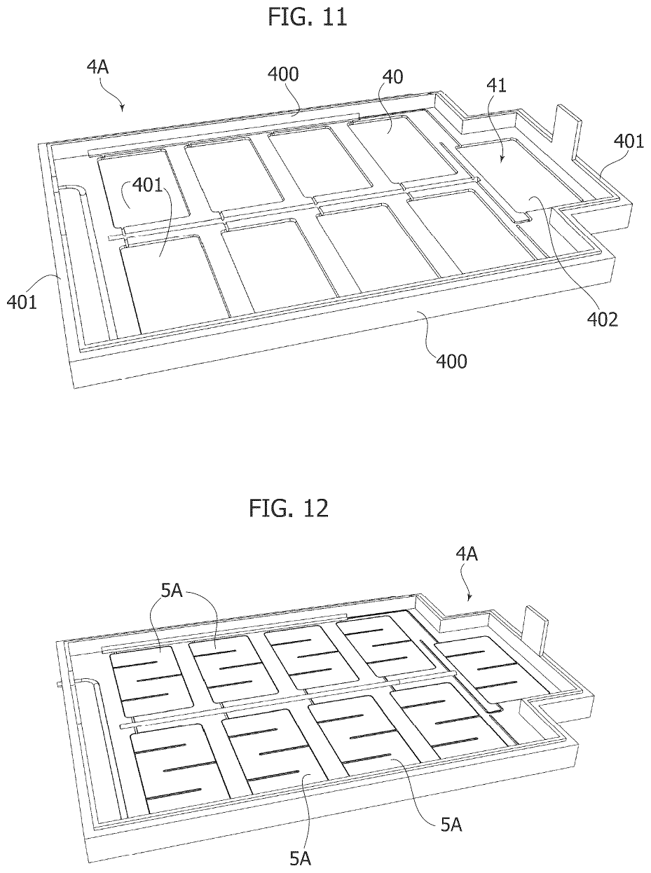

FIGS. 11-16 are perspective views illustrating the subsequent assembly steps of a further embodiment of the battery pack according to the invention above the vehicle platform of FIG. 1,

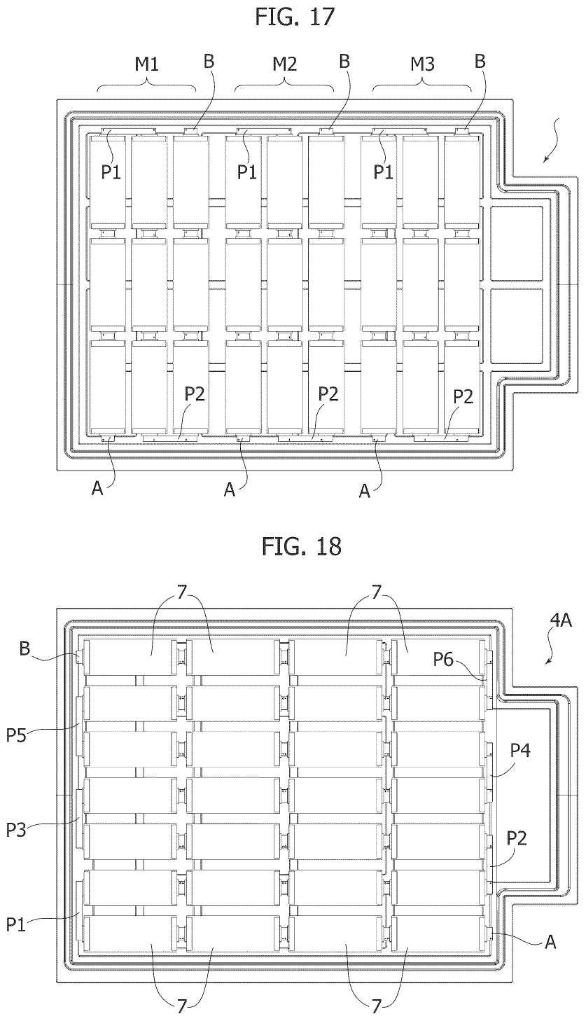

FIGS. 17-21 are schematic plan views of different configurations of the battery pack according to another embodiment of the invention, in which “pouch” type battery cells are provided, arranged in horizontal planes integrated into the vehicle platform,

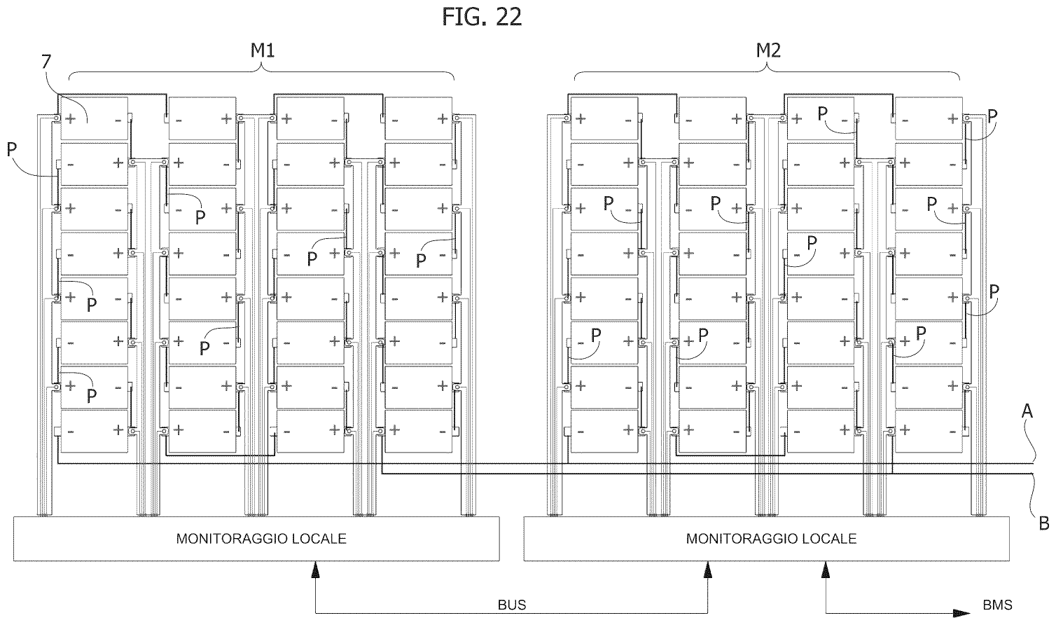

FIG. 22 is a diagram of the wiring arranged to monitor the temperature of each battery cell of the battery pack according to the embodiment, with battery cells arranged in horizontal planes,

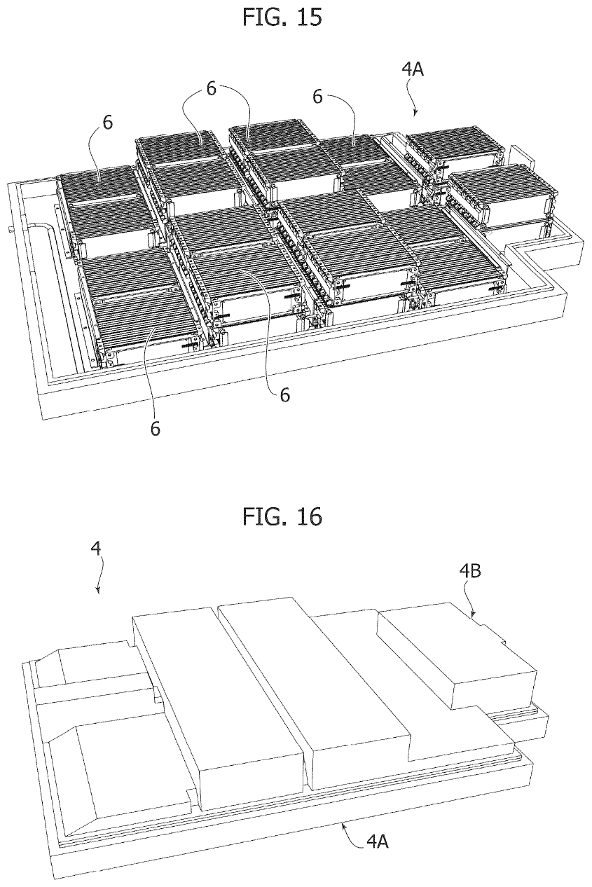

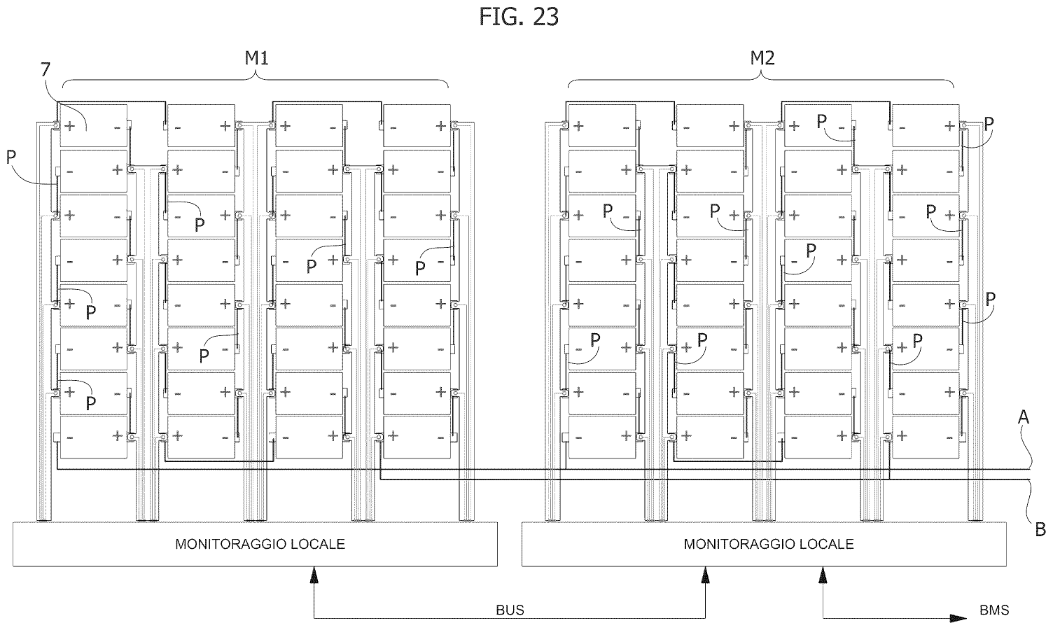

FIG. 23 is a diagram similar to that of FIG. 15, showing the wiring necessary to monitor the charge status and health status (in particular the supply voltage) of each battery cell of the battery pack,

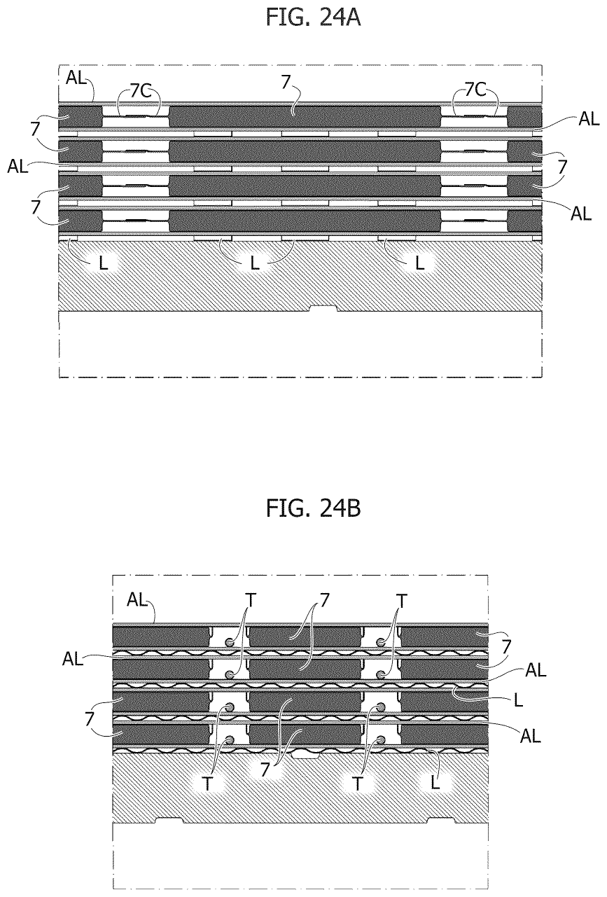

FIGS. 24A, 24B, 25A, 25B, 26A, 26B, 27A, 27B, 28A, 28B, 29A, 29B illustrate a cross-section in a transverse plane of a cross-section in a longitudinal plane of the battery pack according to the invention, in different variants of the invention,

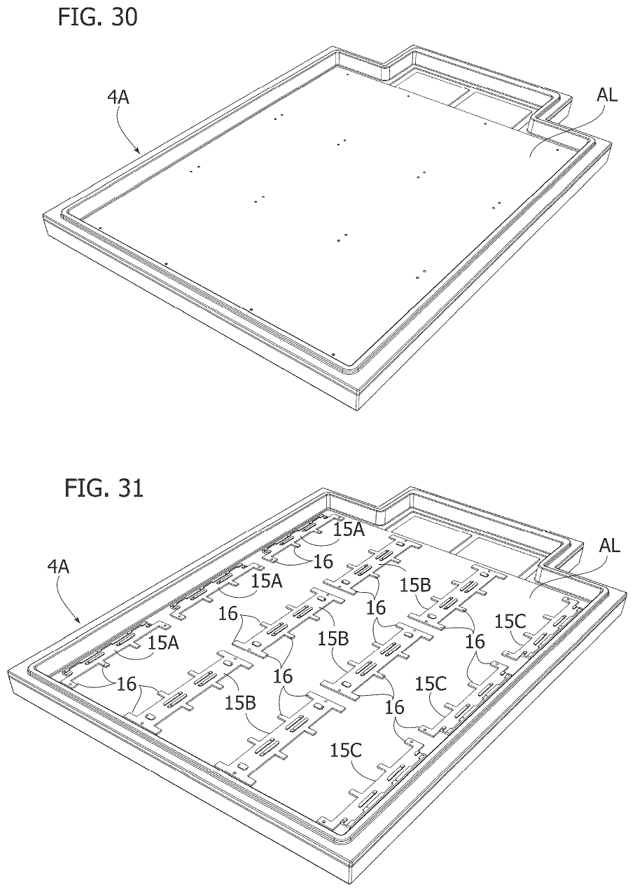

FIGS. 30-38 show different steps of the assembly operation of a preferred embodiment of the battery pack according to the invention.

### VERTICAL CELL “ACCORDION” EMBODIMENT

In FIG. 1, numeral 1 indicates—in its entirety—the structure of an electric city car designed by the same Applicant, including a reticular frame 2, consisting of high-strength steel beams 3. The vehicle 1 comprises a platform 4, which is shown partially cross-sectioned in the Figure, in the form of a planar shell structure, comprising a lower tray 4A and an upper cover 4B, for example, of honeycomb material in molded or thermoformed aluminum, or of synthetic material reinforced with fibers, preferably obtained by a rotational molding technique (although other manufacturing technologies are not excluded). The lower tray 4A and the upper cover 4B define a containment space between them, having substantially predetermined and constant dimensions, for housing a battery pack 5. The battery pack 5 includes a plurality of battery modules 6 each having a classical “accordion” configuration consisting of a plurality of battery cell clusters 7. In the solution illustrated here, the battery cells are of the “pouch” type, which is illustrated in FIG. 4. With reference to FIG. 4, each pouch cell has a substantially flattened and elongated body enclosed in an aluminum coating 7A, defining two longitudinal tabs 7B folded substantially by 90° with respect to the plane of the cell 7, and two electrical terminals 7C. In the example of FIG. 4, the two terminals 7C are at opposite ends of the cell 7, but the case in which the two terminals 7C are at the same end of the cell is not excluded.

FIG. 3 of the attached drawings shows a known solution of the battery module 6, with the battery cells 7 arranged side-by-side in vertical planes. Aluminum sheets 8 are interposed between the battery cells 7, with the object of transporting the heat produced by the cells to the outside where it is then extracted by the cooling system. One or more pads 8A are also provided between the cells, for example, made of silicon sponge with high thermal conductivity and low electrical conductivity (of the type produced by the company Saint-Gobain). In the known solution illustrated in FIG. 3, the pads 8a are capable of being elastically compressed, reducing their thickness, in order to at least partially absorb the elastic variation in thickness of the cells 7 that occurs during the charge-discharge cycle, and the plastic deformation of the cells due to wear and aging of the cells.

FIGS. 5-8 illustrate a first embodiment wherein the principles of the present invention are applied to a battery pack of the type illustrated in FIG. 1, with battery modules having an “accordion” configuration, with pouch-type battery cells placed side-by-side in vertical planes.

The main difference of the embodiment of the invention illustrated in FIGS. 5-8 with respect to the conventional solution of FIG. 3 consists in the fact that in place of a pad made of elastically deformable material (for example, silicon sponge) elastic leaves L are provided. The elastic leaves L are arranged, in the illustrated example, between clusters of battery cells 7, and between at least one of the two end clusters of the module 6 and a containment support of the cells. It is evident, however, that the number and arrangement of the aforesaid elastic leaves may vary as desired, depending on the degree of deformation of the cells that must be absorbed.

As can be seen in FIGS. 5-8, in the example illustrated here, the module 6 comprises a plurality of ECL _{[RSS1]}clusters side-by-side, each formed by three cells 7 side-by-side, arranged in vertical planes. The group of ECL _{[RSS2]}clusters constituting the module 6 is clamped between two end plates 9 connected to each other by means of four screw tie rods each having a head resting against one of the end plates 9 and the opposite end engaged by a nut resting against the other end plate 9.

As a result of the aforesaid arrangement, the size of the battery module in the direction A along which the cells 7 are placed side-by-side is substantially predetermined and constant.

As indicated above, during the charge-discharge cycle of the battery cells and following wear and aging of the cells, the cells are subject to expansions and contractions in the direction A. The present invention has the object of leaving these expansions and contractions free to occur within the predetermined and constant dimension of the containment space of the cells (in the specific example the constant predetermined distance between the end plates 9) with an efficient and low cost.

In the embodiment illustrated in FIGS. 6-8, each elastic leaf L is formed of a metal leaf extending substantially for the entire longitudinal length of the cells 7, and having a cross-section with a wavy profile. In this way, each leaf L is capable of elastically deforming in the direction A, perpendicular to the plane of the leaf between a wavy configuration of maximum bulk and a flattened configuration of minimum bulk. Instead of metallic material, it is of course also possible to use synthetic material. In any case, the arrangement is such as to allow a high operational efficiency, i.e. a high absorption capacity of the expansions of the cells 7 in the face of a reduced space occupied by each leaf L.

Advantages of the Elastic Leaves

The elastic leaves provided according to the invention therefore have a triple advantage with respect to known solutions using pads of elastic spongy material: they have a greater absorption capacity of the expansions of the battery cells, they have a significantly reduced cost compared to that of the pads used in the conventional solutions, and they occupy less space inside the battery module.

Experience has shown that in the case of pouch-type battery cells with electrodes with a high percentage of silicon, the increase in the elastic electrothermal thickness of each cell may reach 10% of the initial cell thickness. For most of the composite materials used for the cell electrodes, the elastic deformation of the cell is usually contained between 1 and 2 percentage points. Plastic deformation due to wear and aging is added to the elastic deformation. For pouch-type lithium ion cells, this plastic deformation can also reach 10% of the cell thickness. This means that, as a result of wear and aging, a battery cell decreases its energy conservation capacity from 100%, for example, to 80% and—at the same time—plastically increases in thickness up to over 10%. The elastic and plastic deformation of a cell induces pressure on the adjacent cell. This pressure may reach values of several kg per cm². With these pressure loads, the cell operation is severely compromised, and gives rise to accelerated aging, loss of performance and safety problems due to the formation of highly flammable or explosive gases leaking from the cell.

In the present invention, each cluster of the battery module in the “accordion” configuration is designed in such a way as to allow large percentage deformations of the cells without inducing pressure on the adjacent cells, while allowing for robust attachment of the cells in each cluster and in the module.

Each elastic leaf L has the function of spring-flexure and is able to perform millions of cycles without losing its elastic characteristics.

Preferably, each leaf L is fixed at a central point of the leaf or along a central longitudinal strip of the leaf so as to be able to elongate towards the sides.

In a concrete embodiment, each leaf L has a width of between 3 cm and 5 cm, and consists of a hardened steel sheet with a thickness of between 0.2 mm and 1.0 mm.

FIG. 9 illustrates an embodiment variant of the elastic leaves L. In this case, a panel P of metallic or synthetic material comprises a plurality of leaves (which—in the case of metallic material—can be obtained by shearing and deformation) L protruding from the panel P and extending in planes parallel and spaced apart from the plane of the panel P, in such a way that each leaf L is elastically deformable between a configuration of maximum bulk wherein it is spaced apart from the plane of panel P, and a configuration of minimum bulk in which it is contained in the plane of the panel P.

With reference again to the solution of FIGS. 6-8, the total deformation of the cells 7 that constitute a single cluster CL is absorbed by the respective elastic leaf L, which expands vertically to allow deformation. The allowed deformation field is equal to the height of the corrugation of each leaf L reduced by the thickness of the strip constituting the leaf. Within a single cluster CL, the expansion or contraction of one or more cells is allowed by the deformation of the elastic leaf. The compression forces are discharged on the two end plates 9 and on the tie rods 10. The cells are also allowed small displacements, as they are not rigidly constrained to the end supports of the clusters CL.

Preferably, each spring-flexure leaf L is inserted between two aluminum sheets. Each leaf L has a width of 3-7 cm (vertically) and is as long as a respective cell 7. The leaf is fixed at its center to allow the leaf to elongate in the direction of its opposite sides.

In both embodiments illustrated, a sheet of plastic or metal material is preferably interposed between each elastic leaf L and the cell 7 adjacent thereto, in order to avoid the risk of damage to the cell following rubbing against the leaf.

Thanks to the arrangement described above, the set of cells 7 within a module 6 is able to “breathe” freely, expanding and contracting within the containment space defined between the two opposite end plates 9, which has a predetermined and constant dimension.

Preferably, the profile of the leaf L is configured in such a way as to give rise to a progressive compression action, greater in the center of the leaf L than the edges of the leaf.

Obviously, the leaves L may be used in combination with thin and cheap pad sheets with high thermal conductivity and low electrical conductivity inserted between a cell and the aluminum sheets. In this case, the spongy pad sheets have the function of ensuring a homogeneous transmission of heat between the cell and the aluminum sheet.

FIGS. 11-16 show the subsequent steps in assembling the vehicle battery pack illustrated in FIG. 1.

FIG. 2 shows the tray 4A, which is preferably made of thermally insulating composite material and can be made, for example, by molding or thermoforming a honeycomb aluminum composite sheet, or by rotational molding of composite plastic material. The tray 4A includes a flat bottom wall 40 having a main dimension parallel to the longitudinal direction of the vehicle. Two side longitudinal edges 400 and two end edges 401 protrude from the bottom wall 40. At one of these ends, the platform has a narrow central portion 41, this configuration being determined by the need to avoid interference between the platform and the housing areas of the two rear wheels of the vehicle. The bottom wall of the tray 4A is configured with lowered areas 402 _{[RSS3]}(in the example, two parallel rows of four areas 402 each are provided, to which a single area is added at the end portion 41).

In the case of the arrangement illustrated in FIG. 1, the assembly of the battery pack begins with the deposition above the lowered areas 402 of as many pad sheets 5A consisting of an elastically deformable spongy material, configured to increase or decrease in thickness, so as to support the vibrations-stresses of the “accordion” modules 6 during the exercise.

In a preferred embodiment, hollow flat panels are laid on top of the aforesaid pad sheets 5A (which can be, for example, in the form of pads of the type produced by the company Saint-Gobain), traversed by a coolant (typically glycol) and connected together by tubes having an inlet and an outlet, in turn connected to a heat pump system.

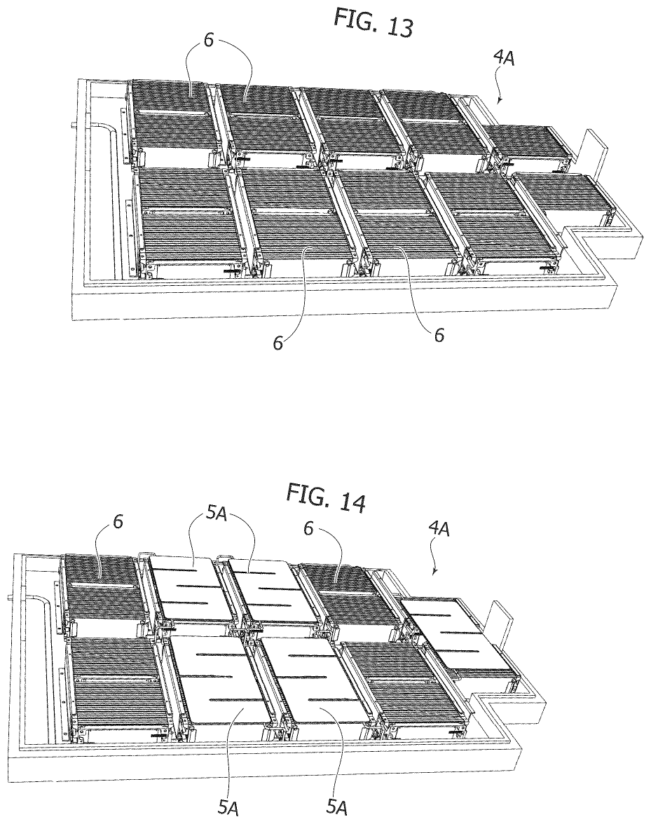

The previously assembled battery modules 6 are arranged above the cooling plates, as shown in FIG. 13, so as to create a first layer of battery modules 6, after which additional pads 5A are applied over the modules 6, made of spongy material with high thermal conductivity and low electrical conductivity, and elastically deformable in the thickness direction (FIG. 14). Above the pads 5A, further cooling plates are applied, above which a second layer of battery modules 6 is deposited (FIG. 15).

FIG. 16 shows the assembled battery pack, with the cover 4B applied over the lower tray 4A.

Embodiments with a “Lasagna” Arrangement (Horizontally-Oriented Cells)

FIGS. 17-23 of the attached drawings show different variants of a preferred embodiment of the invention, wherein the battery cells are of the pouch type, and are arranged with their planes lying horizontally, according to layers parallel to the general plane of the tray 4A, according to a configuration that was baptized by the inventors as a “lasagna arrangement”, in analogy to an Italian cuisine specialty.

FIG. 17 illustrates a first embodiment of the invention. In the case of this example, three battery modules M1, M2, M3 are arranged side-by-side horizontally. Each of the three modules M1, M2, M3 consists of three side-by-side rows of cells 7 having their planes arranged horizontally. The three rows of cells of each module M1, M2, M3 are directed transversely with respect to the longitudinal direction of the tray 4A. The cells are connected in series with each other according to a serpentine path. The battery module M1 has a first terminal A. Each battery module has a first terminal A at one end of a first row of cells. The opposite end of this row is connected to the cell of the adjacent row by means of a bridge connection P1. The same applies to the opposite end of the second row of cells, which is connected by a bridge P2 to the adjacent cell of the third row. At the opposite end, the third row is connected to a terminal B. This arrangement is identical for each of the three modules M1, M2, M3. Each module therefore has a 1p9s configuration (where 1p indicates the number of cells connected in parallel in the cluster, and 9s indicates the number of cells connected in series. The three modules M1, M2, M3 are arranged on a single aluminum sheet as wide and as long as the entire platform.

The arrangement of the cells 7 in several superimposed layers, with the elastic leaves of the invention interposed between them, will be described in detail below with reference to FIGS. 24-29.

FIG. 18 shows a variant wherein individual battery cells 7 are always arranged with their planes parallel to the general plane of the lower tray 4A, in several rows directed parallelly to the longitudinal direction of the tray 4A, each cell 7 also being arranged with its longitudinal dimension parallel to the longitudinal direction of the tray 4A. In this case, seven rows of cells 7 are arranged side-by-side, each row being made up of four cells. The 28 cells arranged as such are connected in series with each other according to a serpentine arrangement of the type 1p28s which goes from a terminal A, through successive bridge connections P1, P2, P3, P4, P5, P6, up to an opposite terminal B.

Assuming the arrangement of battery cells capable of delivering a voltage Vc, in the case of the embodiment of FIG. 18, each layer-module of 28 battery cells gives rise to a nominal voltage of 28×Vc. In the case of three layer-modules of cells of the type illustrated in FIG. 18, the total capacity or energy that can be accumulated in the battery pack is 28 (number of cells of each layer-module)×3 (number of layer-modules)×capacity of the single cell.

In general, the voltage of the pack may be varied by increasing or decreasing the number of cells in each layer-module. For example, if each module layer consisted of 81 cells, the total voltage of each layer-module would be approximately 81×Vc. If each pack consisted of six layer-modules, the overall capacity of the pack would be doubled. Obviously N cells in each layer-module can be connected in parallel in a sub-cluster connected in series with other M clusters to constitute a layer-module in an NpMs configuration. Similarly, the module-layers, instead of being connected in parallel, can be connected in series. Voltage and capacity of the pack may then be defined by changing the connection between cells and between layers.

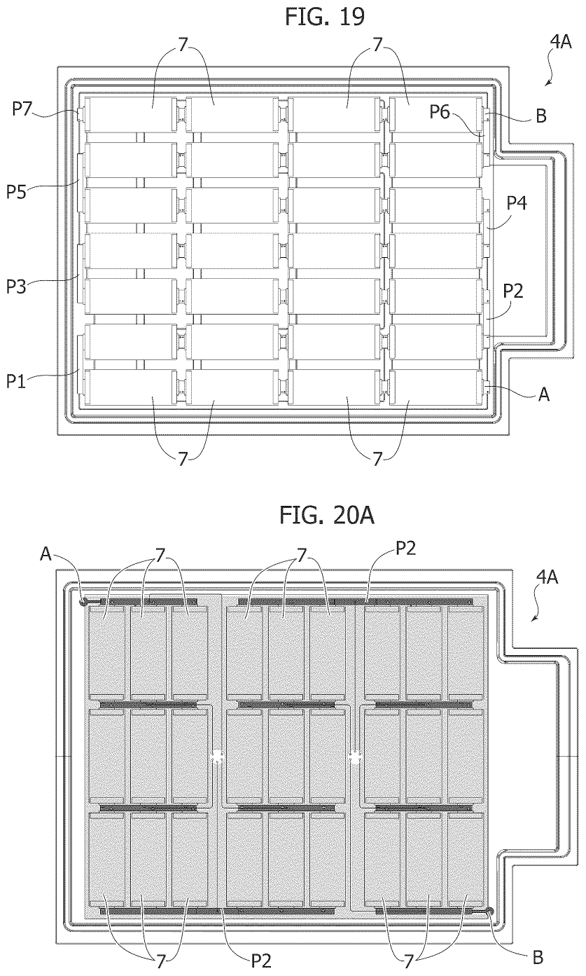

FIG. 19 is substantially identical to FIG. 18, except that in this case there are eight side-by-side rows of cells 7, each row being made up of four cells. The total number of cells is therefore 32, which implies a layer-module in a basic configuration of the 1p32s type, with a nominal supply voltage of 32×Vc. As for the solution of FIG. 18, in the single module-layer N, cells may be connected in parallel in a cluster, and M clusters may be connected in series in a planar module layer configured NpMs.

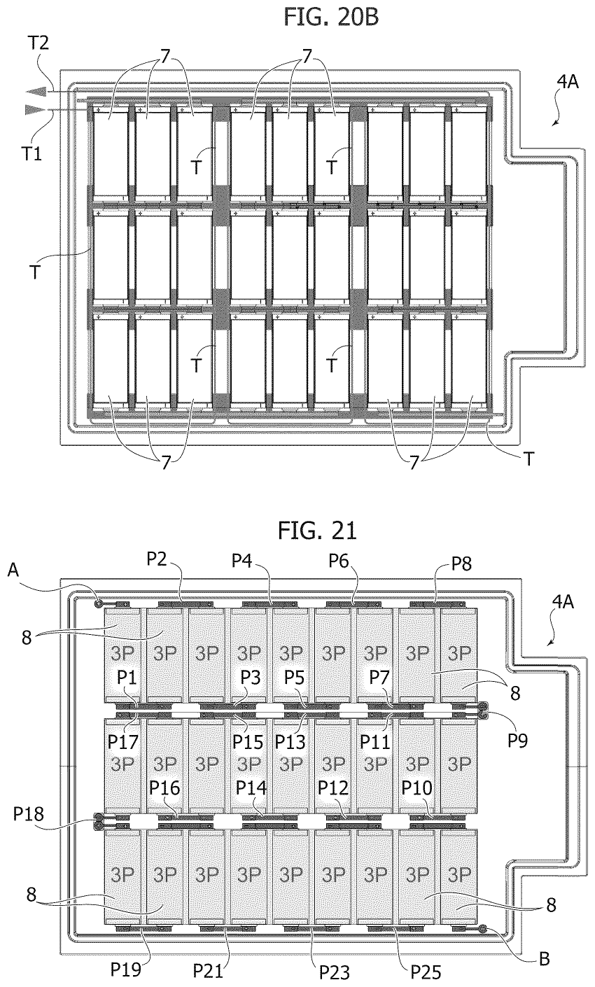

FIG. 20A shows another arrangement, which has the fundamental characteristic in common with all the others of arranging the cells 7 with their horizontal planes parallelly to the general plane of the lower tray 4A. In this case, unlike the solutions of FIGS. 18 and 19, the cells 7 are arranged with their longitudinal directions perpendicular to the longitudinal direction of the tray 4A. The cells are connected in parallel to each other in groups of three. The clusters of three cells thus connected are—in turn—connected in series with each other according to a serpentine path, in a module configured 3p9s. In this way, a first terminal A is connected in series to an opposite terminal B by means of connections in series between the clusters of three cells of each transverse row, and by means of the two bridge connections P1, P2. The planar layer-module voltage shown in FIG. 20 is therefore 9×Vc. Each layer forms a module that can be connected in series with other layers. In the case of three layers, the overall pack has a 3p27s configuration and a total voltage of 27×Vc. In relation to the size and capacity of the cells, both the level of parallelism in a cluster and the level of the overall series may be varied.

FIG. 20B shows a solution wherein cooling is obtained by means of a serpentine arrangement of tubes T, preferably of aluminum, passed through by a cooling liquid (glycol) that passes between the cells, on one or more layers of the lasagna configuration. T1 and T2 are the inlet and outlet of the cooling circuit.

FIG. 21 illustrates yet another variant, wherein clusters 8 of three cells connected in parallel are formed, all arranged horizontally, with their planes parallel to the general plane of the lower tray 4A. Each cluster 8 consists of three cells arranged horizontally and superimposed on each other. In this case, the cells are arranged with their longitudinal directions perpendicular to the longitudinal direction of the lower tray 4A. Furthermore, the clusters 8 each consisting of three superimposed cells form three rows adjacent and parallel to the longitudinal direction of the lower tray 4A, which are connected together in series in modules configured 3p9s, with the clusters 8 of each of the longitudinal rows also connected in series with each other. Thus, a terminal A is connected to a terminal B through the succession of bridge connections P1, P2, P3, P4, P5, P6, P7, P8, P9, P10, . . . P26. Each cluster may also be composed of more than three cells 7 superimposed on each other and connected in parallel, the number n of superimposed cells being able to vary between 1 and a number >10, depending on the energy capacity required Embodiments in relation to cluster stratification will be described in detail below with reference to FIGS. 24-29.

Assuming the arrangement of battery cells 7 capable of delivering a voltage Vc, the arrangement of FIG. 21, multiplied on three levels, gives rise to a nominal voltage of 27×Vc. The total capacity or energy that can be accumulated in the battery pack is 27 (three 3p9s modules for each layer)×3 (number of layers)×capacity of the single cell.

In general, the voltage of the pack may be varied by increasing or decreasing the number of cells in each module. For example, if each module consisted of 27 cells in the 3p27s configuration, the overall voltage would be three times higher. If each cluster were made up of six cells connected on six layers in parallel, the overall capacity of the pack would be doubled.

FIGS. 22, 23 show two battery modules M1, M2, in a 1p32s configuration, each consisting of four adjacent rows of battery cells 7 connected to each other in series, according to a serpentine path starting from a terminal A up to a terminal B, through a succession of bridge connections P. FIGS. 22, 23 also show the wirings connected, respectively, to temperature sensors associated with all the cells 7, and to voltage sensors associated with all the cells 7, which allow monitoring of the temperature and voltage supplied by each cell.

Stratification of Cells Arranged in a Lasagna Configuration (Horizontally Oriented) with Interposition of Elastic Leaves

It should be noted that the arrangement in one or more layers of horizontally oriented pouch-type cells (according to the so-called “lasagna” arrangement) can also constitute an invention considered in its own right. However, preferably, also in the case of this embodiment, provision is made for the interposition of one or more elastic leaves between at least some layers of battery cells and/or between at least one layer of battery cells and a containment support adjacent thereto. FIGS. 24-29 illustrate various variants within this embodiment. For each pair of Figures, the Figure marked by the letter A refers to a cross-sectional view of the lower tray 4A and of the battery pack arranged above it in a transverse plane with respect to the longitudinal direction of the vehicle platform. The Figure marked by the letter B, instead, shows a cross-sectional view of the lower tray 4A with the battery pack above it, in a plane parallel to the longitudinal direction of the platform.

With reference to the variant of FIGS. 24A, 24B, four superimposed layers of pouch-type battery cells 7 are provided with their planes arranged horizontally, parallelly to the lower tray 4A. In this example, each layer of cells comprises several side-by-side rows directed transversely to the longitudinal direction of the platform. Each row of cells consists of three cells connected in series (FIG. 24A), with the cells having their longitudinal direction oriented transversely with respect to the longitudinal direction of the platform.

Between the platform and the layer of cells arranged above it, as well as between layers of cells adjacent to each other, there are elastic leaves L. Each layer of elastic leaves L comprises a plurality of leaves in the form of metal strips having a wavy conformation (FIG. 24B) and extending in the longitudinal direction of the platform.

Both faces of each cell 7 have a layer of high thermal conductivity dielectric glue. Aluminum sheets AL are interposed between each layer of cells and the elastic leaves L. An aluminum sheet AL is also arranged above the upper layer of cells 7. The cooling is obtained by means of a serpentine arrangement of tubes T, preferably made of aluminum or copper, passed through by a cooling fluid T, said tubes extending into the spaces between the cells of each layer in a transverse direction with respect to the longitudinal direction of the platform.

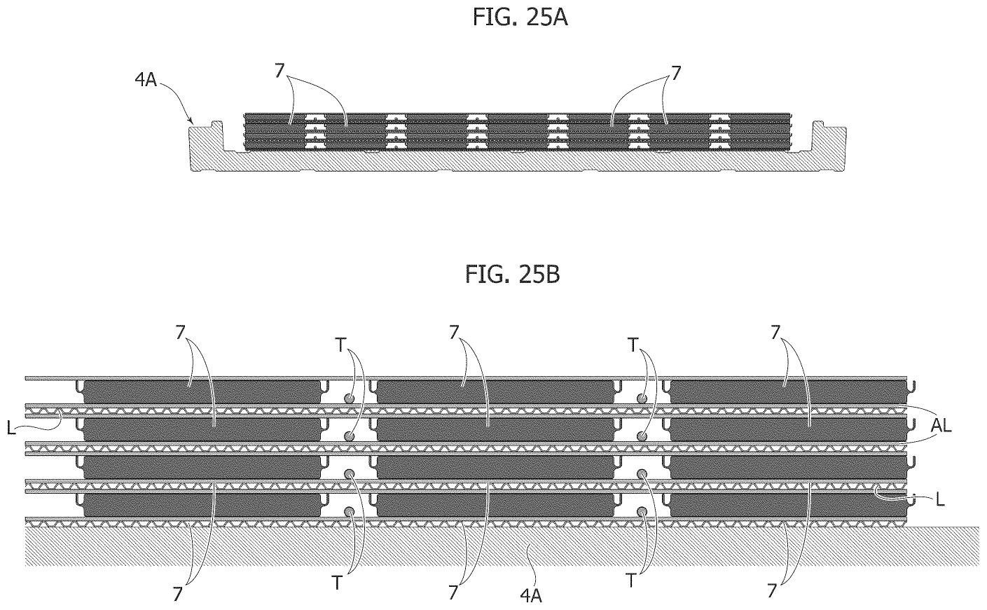

FIGS. 25A, 25B illustrate a solution substantially similar to that of FIGS. 24A, 24B, except for the fact that, in this case, the elastic leaves L have a Greek-style corrugated profile.

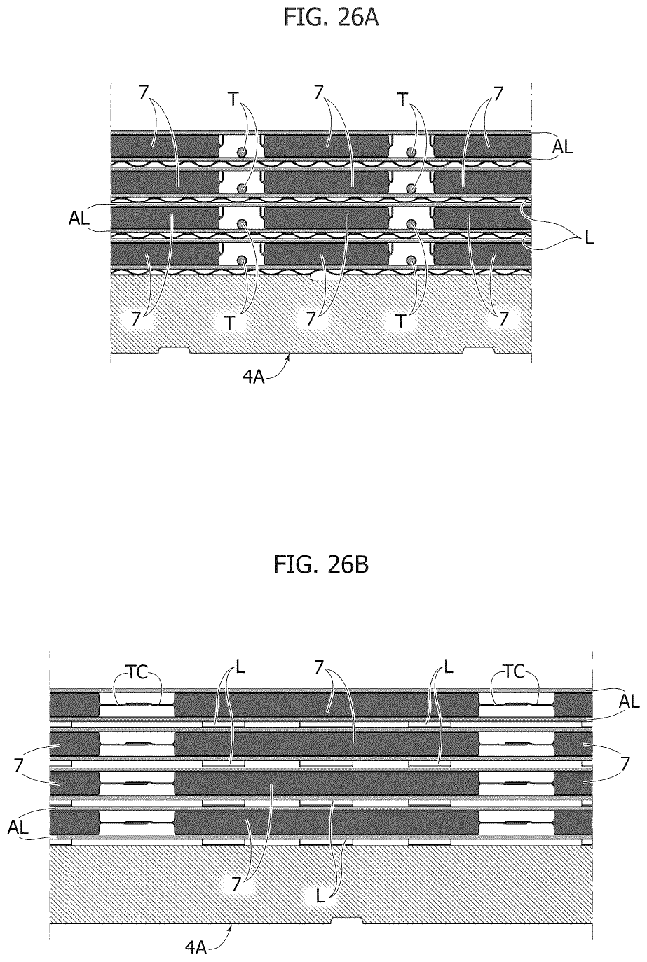

The variant of FIGS. 26A, 26B envisages that the cells 7 are arranged with their longitudinal direction parallel to the longitudinal direction of the platform (see FIG. 26B). In this case, each layer of cells consists of three rows (FIG. 26A) of side-by-side cells, parallel to the longitudinal direction of the platform, each row comprising a plurality of cells connected to each other in series (FIG. 26B). Also in this case, between adjacent layers, several elastic leaves are arranged in the form of corrugated metal strips placed side-by-side, which run perpendicularly to the transverse direction of the platform (FIG. 26A).

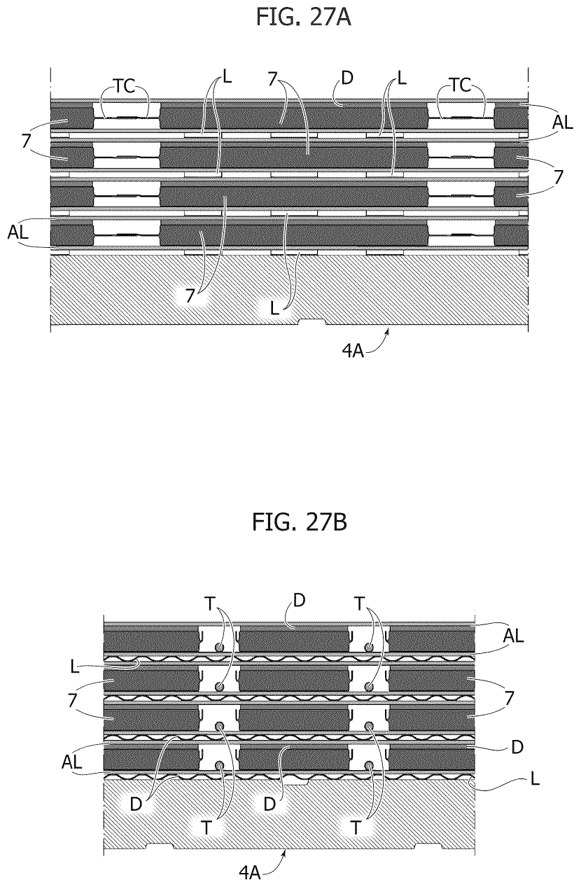

FIGS. 27A, 27B illustrate a variant of the solution of FIGS. 24A, 24B that differs from the latter in that the cells only have a layer of glue on their lower side, while above the upper side of each cell 7 there is a thin spongy pad with high thermal conductivity and low electrical conductivity. For the rest, the arrangement is identical to that of FIGS. 24A, 24B.

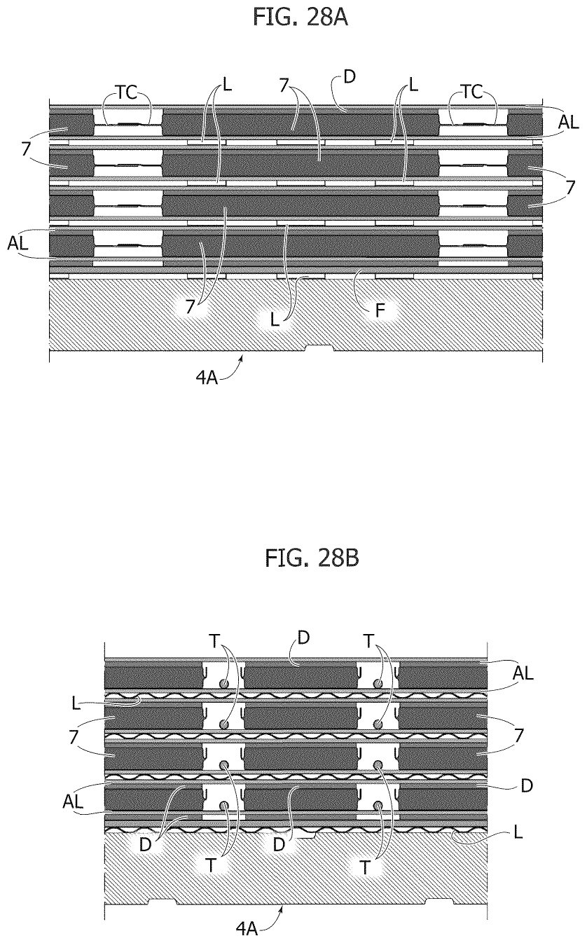

The solution of FIGS. 28A, 28B differs from that of FIGS. 27A, 27B in that instead of the serpentine of cooling tubes T, there is a cooling panel F arranged under the lower layer of cells, and constituted by a hollow panel passed through by a cooling fluid (glycol). Each cell is interposed between two thin spongy adhesive pads on one or both sides.

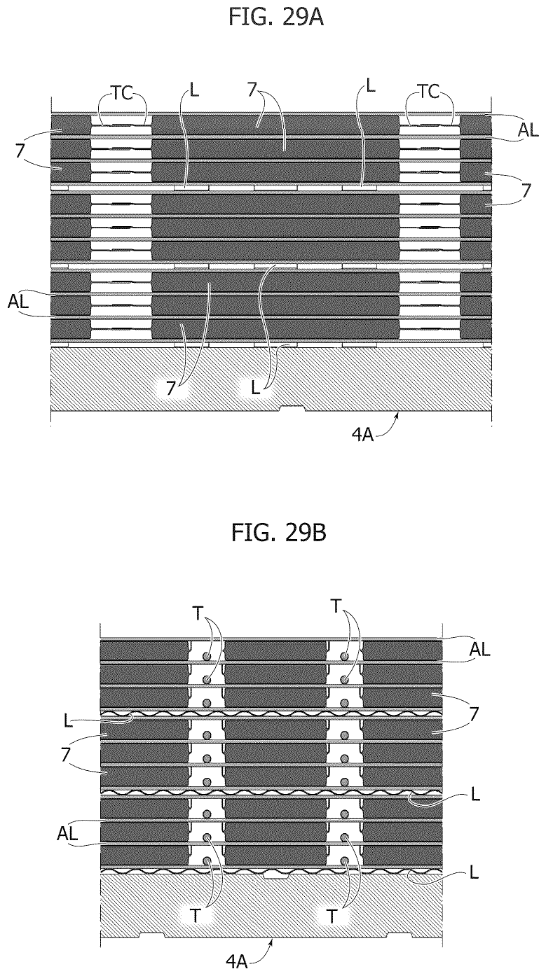

The solution of FIGS. 29A, 29B corresponds to that of FIGS. 24A, 24B except for the fact that, in this case, one layer of elastic leaves L is provided for every three layers of cells L. In the specific case illustrated, nine layers of superimposed cells are provided, one layer of elastic leaves L interposed between the lower tray 4A and the lowest layer of cells, and two additional layers of elastic leaves L between triplets of superimposed layers of cells.

Assembly of the Battery Pack in the Embodiment with Cells Arranged in a Lasagna Configuration

FIG. 30 shows the lower tray 4A constituting the vehicle platform, where a single aluminum plate AL with a thickness between 0.7 mm and 2.5 mm is laid on the bottom wall.

FIG. 31 shows the subsequent step wherein spacer blocks 15A, 15C are positioned above the aluminum plate AL, having holes for engaging screws intended to attach all the layers of cells above the platform 4A. Nuts are inserted into each block 15A, 15B, 15C for clamp members (described below) serving to block the contacts of the cells. The blocks 15 may be screwed or glued to the aluminum plate AL. Preferably, the blocks 15 are made of plastic material. They have comb-like appendages 16, which act as spacers between the cells of each layer.

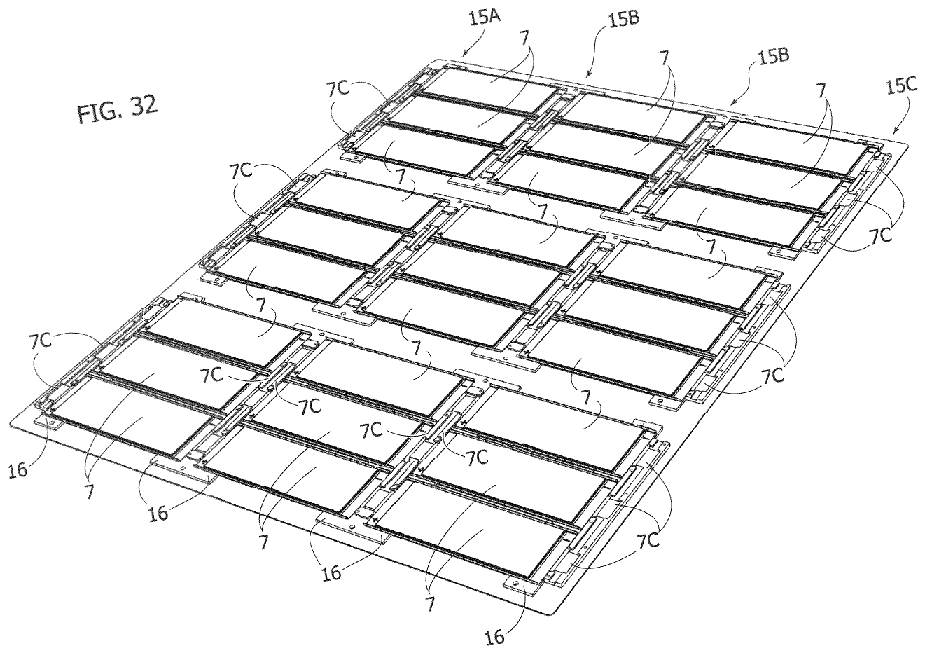

With reference to FIG. 32, after having positioned the blocks 15 with the comb-like appendages 16, the cells 7 of a first layer can be glued onto the aluminum plate AL. As already indicated, as an alternative to gluing, thin spongy pads (0.2 mm-0.5 mm), preferably adhesive on one or both sides, are positioned between the cells 7 and the aluminum plate AL. The contacts 7C of the cells 7 overlap each other for almost their entire length, in order to maximize the electrical contact area.

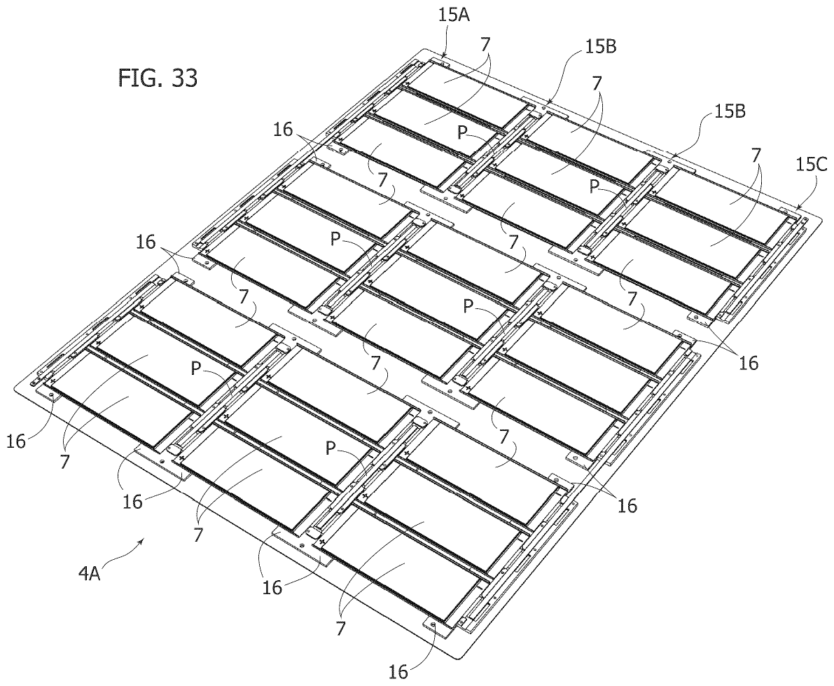

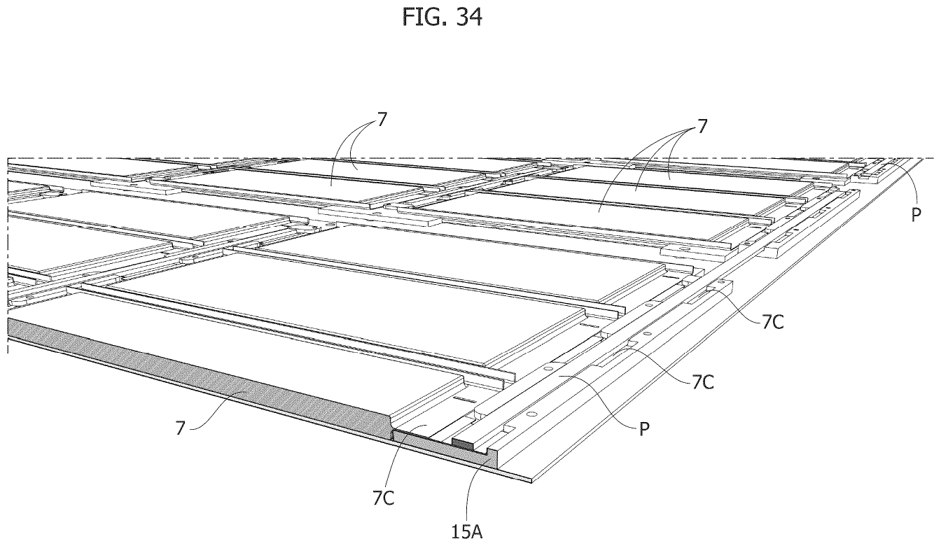

With reference to FIG. 33, after having positioned the cells 7, the cells are connected in parallel in clusters of three by means of the connection bridges P, so as to connect in series the clusters each consisting of three cells in parallel, by means of the connection bridges P. These connection bridges consist of bars or braids of copper wires positioned on the contacts 7C of the cells 7, which in turn are superimposed on each other. FIG. 34 shows a perspective view of the detail of the copper bars P.

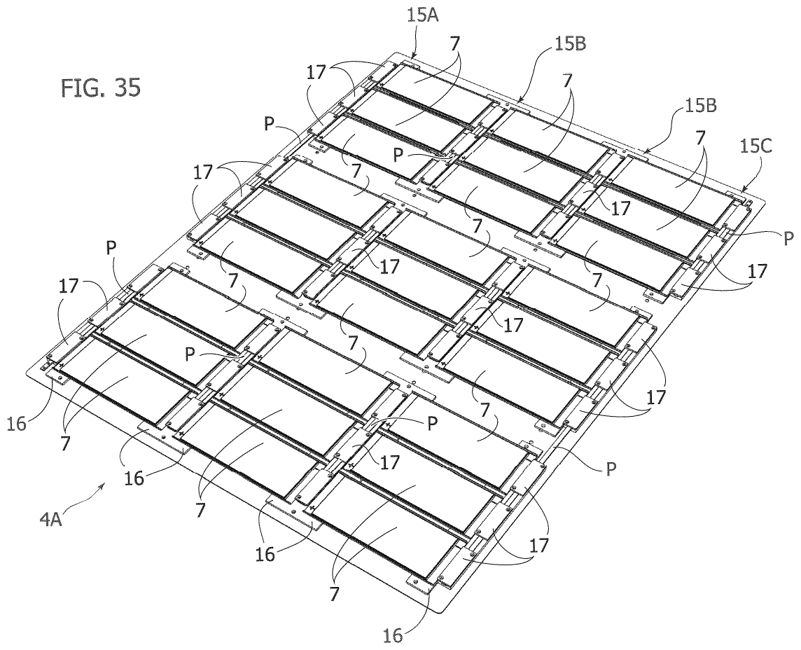

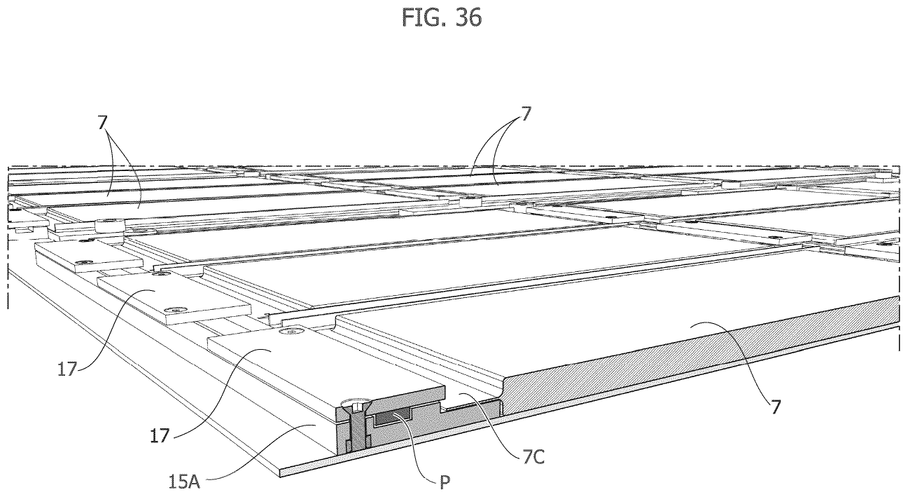

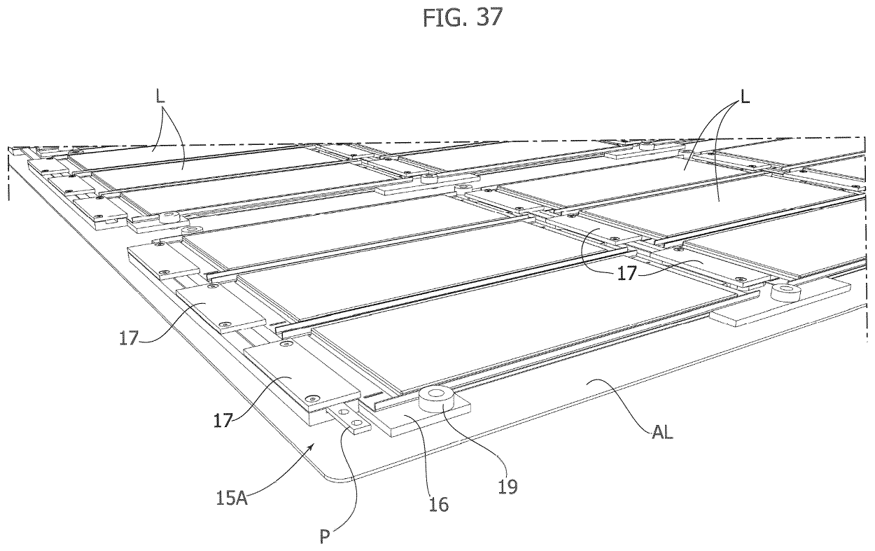

With reference to FIG. 35, the contacts of the cells 7 and the copper bars P are tightened by means of upper blocks 17, which are screwed onto the lower blocks 15A, 15B, 15C. In the example illustrated in FIG. 35, each upper block 17 has a length corresponding to the width of a single cell 7, but it can be envisaged that the blocks 17 of each row of blocks 17 form part of a single longitudinal member extending for the entire length of the platform. FIG. 36 shows an embodiment variant of the upper blocks 17, fixed by means of screws E18 to the lower blocks 15

With reference to FIG. 37, spacer bushings 19 are also arranged above the blocks 15A, 15B, 15C, made of plastic material (24 bushings for each level) on which the aluminum plate AL is placed, which is arranged above the first layer of cells. A layer of elastic leaves L is arranged above this aluminum sheet, according to the arrangement illustrated in FIGS. 24A, 24B. A layer of elastic leaves L may also be arranged between the lower tray 4A and the lower aluminum plate AL, according to that envisaged in the solution of FIGS. 24A, 24B. Furthermore, between the cells of each layer, the serpentine of cooling tubes T is arranged, in accordance with FIGS. 24A, 24B.

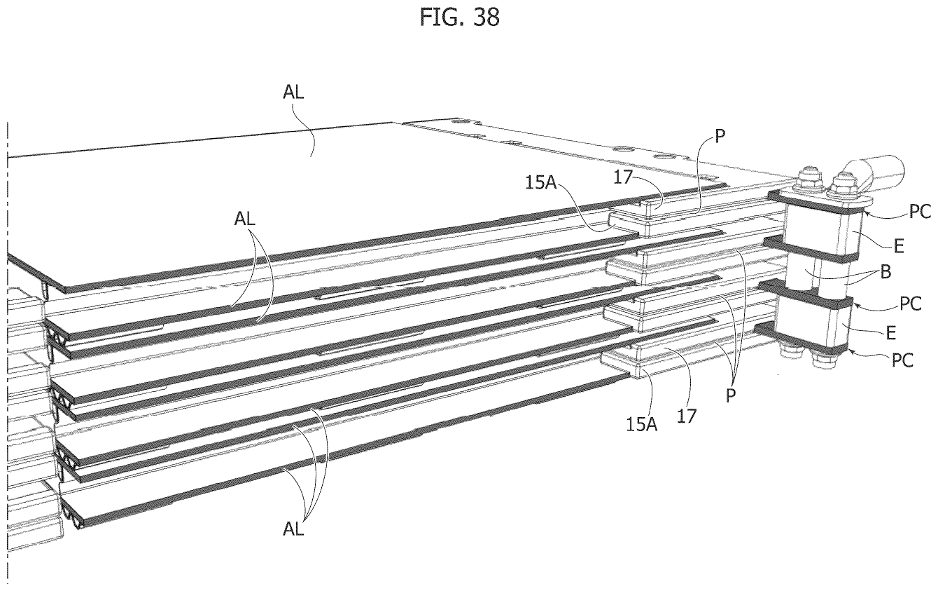

The electrical connection between the cells of different layers is achieved by means of terminals arranged at the corners of the battery pack, as shown in FIG. 38. The terminals of the cells of the different layers are electrically connected to the bars P of the different layers. The bars P are connected to plates PC that protrude from a vertex of the battery pack and are arranged superimposed and spaced apart, with the interposition of insulating blocks E crossed by connection pins B.

The sheets of the first and last of the layers of the lasagna configuration may be of high resistance steel with a thickness between 0.4 mm and 0.7 mm.

The tightening of the sheets that make up the lasagna battery pack creates a highly rigid multilayer structure, which in turn is attached to the platform. Once fixed to the rest of the chassis structure, the overall platform-battery system becomes a highly resistant structural element that contributes to the impacts caused by both side and front crash tests.

### Advantages of the Invention

Thanks to the characteristics indicated above, the battery pack according to the invention achieves a series of important advantages.

Firstly, the configuration of the battery pack according to the present invention ensures the maximum level of safety and robustness, taking into account the electro-thermal variations of elastic shape that occur during the charging and discharging cycle of the battery cells, and the permanent or plastic structural variations induced by continued use and cell aging.

A further important advantage of the invention is obtained in the embodiment with horizontal “lasagna” arrangement of the cells, and consists of a high specific and volumetric energy density of the battery pack. This means that, in the aforesaid configuration, the increase in weight and volume due to the assembly of all the additional components with respect to the battery cells, necessary to produce the battery pack is extremely low in relation to the weight and volume of the battery cells alone.

Another advantage of the battery pack according to the invention consists of the fact that the arrangement of the battery cells defined above allows the battery cells, the cell clusters and the modules formed by the cell clusters to be assembled in succession with relatively simple and easily automatable operations, analogously to the technology of planar electronic components. The same applies to the assembly operations of the battery pack on the vehicle. It is, in fact, possible to compose the battery pack in layers, starting by preparing the lower tray of the vehicle platform, and then overlapping the various layers, keeping the battery cells oriented with their planes arranged horizontally, parallel to the general plane of the tray, according to the cited lasagna configuration.

The aforesaid configuration with battery cells arranged in horizontal planes allows simplified wiring to be adopted in order to monitor the temperature and the health status of each battery cell. The configuration of the battery pack according to the invention facilitates the thermal conditioning of the battery pack by means of thermal insulation of the casing that contains it. The planar aluminum sheets ensure uniformity of the temperature in the entire volume of the battery pack, allowing separation into zones of the battery pack in order to avoid the propagation of high temperatures or a flame between the layers. The attachment system of the battery cells is robust and resistant to both high frequency vibrations and the stresses deriving from impacts such as those occurring in automobile crash tests required for approval.

The stratification of the battery pack in the lasagna configuration can be carried out according to any of the configurations described and illustrated above.

The arrangement illustrated in FIG. 17, multiplied on three levels, gives rise to three modules M1 connected in series, which form the string 3×M1 with configuration 1p27s. Assuming the arrangement of battery cells capable of delivering a voltage Vc, a string gives rise to a total nominal voltage of 27×Vc, where Vc is the voltage of a single cell. Similarly, the modules M2 and M3 have connections in series to form the second and third layers. The three layers are instead connected to each other in parallel.

The main characteristic of the present invention, relating to the arrangement of the elastic leaves between the battery cells, may of course also be applied to battery cells with different configurations, in particular to prismatic cells and to cylindrical cells. Furthermore, the invention is applicable to cells with a liquid, gel, or solid state electrolyte.

The invention is also applicable to the case where all the layers are immersed in a dielectric liquid with high thermal conductivity.

The glues used to fix the battery cells to aluminum (or steel) sheets are dielectric types with high thermal conductivity, such as the glues usually used in the field of electronic packaging.

Various types of spongy pads with high thermal conductivity and low electrical conductivity are possible, the pads have the function of making the cells adhere to the aluminum sheets without air bubbles, and are preferably between 0.2 mm and 3.0 mm thick. The pads may have an adhesive layer on one or both sides.

In the case of cylindrical cells, the aluminum sheets may be preformed in such a way as to maximize the contact surface.

In general, the terminals D of the cells are electrically connected to each other without the need for welding, but laser welding is however envisaged, as well as the case wherein the electrical connection between the terminals of different cells is improved by adding a paste with high electrical conductivity.

The lower tray constituting the vehicle platform can be made by rotational molding or, alternatively, it can be made up of a composite structure including an outer molded sheet, an insulating layer and an inner sheet layer; a further alternative is the thermoforming of a honeycomb composite. The configuration of the platform can, in general, be varied according to the specific application.

Finally, it is noted that, in the present description and in the following claims, where it is indicated that the elastic leaves occupy a relatively small space between the battery cells, it is intended that this space is not greater than the thickness of the battery cells, and is preferably less than this thickness, even in the condition of maximum bulk of the elastic leaves.

Of course, without prejudice to the principle of the invention, the details of construction and the embodiments may vary widely with respect to those described and illustrated purely by way of example, without departing from the scope of the present invention.

1. A battery pack for the propulsion of an electric means of transport, wherein the battery pack comprises a plurality of battery modules, each of which includes a plurality of clusters of battery cells, which are arranged side-by-side with each other, along a determined direction, within a containment space having a substantially constant dimension along said direction,
wherein at least between some of said battery cells, and/or between said battery cells and one or more containment supports for the battery cells one or more elastic leaves are interposed, configured in such a way as to occupy a relatively small space between the battery cells in the aforesaid direction, while leaving the battery cells free to expand and contract, to a predetermined maximum extent, within the aforesaid containment space, along said direction due to electro-thermal variations that occur during the charging and discharging cycle of the battery cells and due to structural changes in the battery cells caused by continued use and/or aging of the battery cells
wherein said battery cells are positioned above a lower tray having a longitudinal direction and a transverse direction,
wherein said battery calls are pouch-type cells a having a substantially flattened and elongated body,
wherein the battery cells are arranged horizontally over a lower tray, according to a lasagna configuration,
wherein:
said lower tray is configured to constitute a vehicle platform,
the battery cells are arranged in layers over the vehicle platform. each layer of battery cells comprising a plurality of modules of battery cells. wherein each module of battery cells comprises a plurality of parallel rows of battery cells with corresponding modules of different lavers being connected in parallel or in series with each other and
each layer of battery cells is interposed between two aluminum sheets substantially extending over the entire area of the vehicle platform.

2. (canceled)

3. (canceled)

4. (canceled)

5. (canceled)

6. (canceled)

7. (canceled)

8. (canceled)

9. (canceled)

10. A battery pack according to claim 1, wherein said battery cells are arranged with their longitudinal direction arranged perpendicularly to the longitudinal direction of the lower tray.

11. A battery pack according to claim 1, wherein said battery cells are arranged with their longitudinal direction arranged parallelly to the longitudinal direction of the lower tray.

12. (canceled)

13. A battery pack according to claim 1, wherein the elastic leaves are arranged in several layers interposed between the layers of battery cells, each layer of elastic leaves being constituted by a plurality of metal strips arranged horizontally side-by-side, in a direction parallel to the longitudinal direction of the lower tray or in a direction perpendicular to this longitudinal direction, each layer of elastic leaves being separated from the battery cells of the lower layer and from the battery cells of the upper layer by means of two aluminum sheets which cover the upper side and the lower side of the aforesaid layers of battery cells.

14. A battery pack according to claim 1, wherein each battery cell has at least one face coated with a layer of a highly thermally conductive glue for adhesion to the adjacent aluminum sheet and the opposite face also coated with a layer of glue for adhesion to the adjacent aluminum sheet or covered by a pad of elastically deformable material with high thermal conductivity and low electrical conductivity.

15. A battery pack according to claim 1, wherein tubes are arranged between the battery cells each layer of battery cells, forming part of a circuit for a cooling fluid for cooling the battery cells.

16. A battery pack according to claim 1, further comprising at least one cooling panel arranged between the lower tray and the battery cells and consisting of a hollow panel covered by a cooling fluid.

17. (canceled)

18. (canceled)

19. (canceled)

20. A battery pack according to claim 1, further comprising an aluminum sheet positioned on the bottom wall of the lower tray, with blocks arranged above said aluminum sheet and having comb-like appendages acting as positioners for the battery cells and for electrical connection bars, which are positioned above the terminals of adjacent battery cells to connect said terminals together, said connection bars being locked in position by upper clamps fixed to said blocks.

21. A battery pack according to claim 1, further comprising a cover fixed above the lower tray such a way as to define a closed containment space for the battery cells, said containment space being filled with an electrically insulating and thermally conductive dielectric liquid.

22. (canceled)

23. (canceled)

24. (canceled)

25. A battery pack according to claim 1, wherein the electrical connection between battery cells of superimposed layers is obtained by means of electrical connectors arranged at one or more of the vertices of the aforesaid lower tray.

26. (canceled)

27. (canceled)

28. (canceled)

29. (canceled)

30. (canceled)
